(19) United States
(12) Patent Application Publication
(10) Pub. No.: US 2008/0086952 A1
(43) Pub. Date: Apr. 17, 2008

(54) Protective door shield

(76) Inventor: Matthew Joseph Holwick, Pauma Valley, CA (US)

Correspondence Address: EDWIN TARVER, 16830 Ventura Blvd., SUITE 360, Encino, CA, 91436, US

(21) Appl. No.: 11/581,252

(22) Filed: Oct. 12, 2006

(51) Int. Cl. E04B 1/34; E06B 3/26

(52) U.S. Cl. 52/3; 52/98; 52/202; 150/154; 206/321

(57) ABSTRACT

A shield for protecting doors from damage caused by contact from construction equipment, furniture or other objects carried in and out of a doorway. The door shield comprises a corrugated cardboard rectangular panel with top, bottom, left, and right side edges. The panel includes perforations along a plurality of parallel and spaced apart vertical lines in its right portion and a plurality of parallel and spaced apart horizontal lines in its top portion. The perforations enable tearing of portions of the panel along the vertical and horizontal lines to make the door shield adaptable to different lengths and widths of the doors. The panel also includes perforations along grid lines at a location so as to receive a door handle through a hole formed by tearing portions of the panel along the grid lines.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to door covers, and more particularly to protecting doors within buildings from being damaged during construction, remodeling, or moving; and still more particularly to a protective door shield that is adaptable to be used with doors of all sizes.

Doors are frequently damaged due to inadvertent contact by construction equipment, furniture, or other objects carried in and out through doorways. Based on the extent of the damage, doors may have to be refinished or sometimes replaced at considerable expense. For this reason, door covers are used for protection. When secured, these covers may also provide padding to prevent damage.

Several door cover devices have been developed in art. For example, U.S. Pat. No. 5,255,727 to Saruwatari discloses a two piece door cover assembly that protects all sides and edges of a door on which it is mounted. The assembly comprises first and second sections, each having substantially a rectangular shaped portion for covering the front or back surface of a door and a plurality of flaps with fastening means such as Velcro strips. The front and back surfaces are covered with the first and second sections. The flaps are then wrapped around the side edges of the door, so that the Velcro strips are secured to mating Velcro strips on the exterior surfaces of the first and second sections.

U.S. Pat. No. 5,103,593 to McNaughton discloses a door shield comprising a polymeric foam web and an accordion pleated fold layer mounted coextensively to a forward surface of the web. The accordion fold layer is defined by parallel rib members fixedly secured to the forward surface of the web. The web includes a continuous securing strip mounted to its rear surface for securing the door shield to a door member. The securing strip comprises a magnetic strip mounted coextensively adjacent an adhesive strip. Cylindrical perforations are provided in the door shield to accommodate a door knob. The cylindrical perforations may not accommodate all types of door handles.

U.S. Pat. No. 5,042,656 to Kahre discloses a disposable envelope for protecting interior doors during painting, construction or decorating. The envelope is formed as a rectangular structure having a pair of layers of flexible material. Each layer has a pair of short sides and a pair of long sides. The two layers are secured together along their two short sides and along one of the long sides. The other long sides are left unsecured thereby forming an enclosure with an open mouth large enough to span a door from top to bottom. A door is received through the open mouth of the envelope. The envelopes protect the door from paint, spackle and other material used in construction or decorating. The layers are made of plastic or paper and their thickness may make this envelope unsuitable for preventing damage from heavy objects. Unlike the present invention, the above door cover devices have to be custom made to be used with doors of different sizes.

U.S. Pat. No. 4,372,364 to Katz discloses a door protector that protects doors from damage due to contact with moving furniture. The protector comprises a rectangular body portion adapted to cover the exposed side of the door and a. transverse pocket at the upper end of the body portion. The pocket is closed at its top edge and open downwardly to receive in the top edge portion of a door. The body portion includes excess length at its lower end to form a flap that can be folded up to fit doors of different heights. Hook and latch strips are attached to the body portion and the flap to secure the flap in folded relationship with the body portion, however this door protector is not designed to accommodate doors of various widths.

Although many door cover devices exist in the art, they are customized to the dimensions of the particular door size on which they are to be secured. Therefore, the primary object of the present invention is to provide a protective door shield or cover that has both length and width adjustable features for use with doors of all sizes.

A further object is to provide a protective door shield designed to accommodate door knobs or handles of different sizes and designs.

Finally, it is an object of the present invention to provide a protective door shield that is lightweight, easy to install, and is designed to withstand the impact of heavy objects. These and other objects of the present invention will become better understood with reference to the appended Summary, Description, and Claims.

### SUMMARY

The present invention is a door shield for protecting doors from damage due to inadvertent contact by objects carried through a doorway during construction, remodeling, or moving. The door shield comprises a rectangular corrugated cardboard panel having top, bottom, left, and right edges. The panel includes perforations along a plurality of spaced vertical lines parallel to the right edge and along a plurality of spaced horizontal lines parallel to the top edge. The perforations enable a user to tear off portions of the panel along the vertical lines and the horizontal lines to adjust the door shield to various lengths and widths of the doors.

The rectangular panel also includes perforations along grid lines near the left edge of the panel. Portions of these perforations can be removed along the grid lines to make a suitably sized hole for accommodating door knobs or handles. The grid lines are configured along both vertical and horizontal axes to make the door shield applicable for all types of door knobs and handles.

### BRIEF DESCRIPTION OF THE FIGURES

FIG. 1 is a plan view of the door shield of the present invention.

FIG. 2 is an illustration of a door and the door shield in its folded configuration.

FIG. 3 is an illustration showing the door shield that is unfolded for attachment to the door.

FIG. 4 shows the door shield that is cut along the perforations to match the dimensions of the door.

FIG. 5 shows the door shield attached to the door using adhesive tape.

### FIGURES—REFERENCE NUMERALS

10 . . . Door Shield
11 . . . Rectangular Panel
12 . . . Top Edge
13 . . . Bottom Edge
14 . . . Left Edge
15 . . . Right Edge
16 . . . Vertical Line
17 . . . Horizontal Line
18 . . . Handle Grid
19 . . . Fold Line
20 . . . Door
21 . . . Door Handle
22 . . . Hole
23 . . . Adhesive Tape

### DETAILED DESCRIPTION

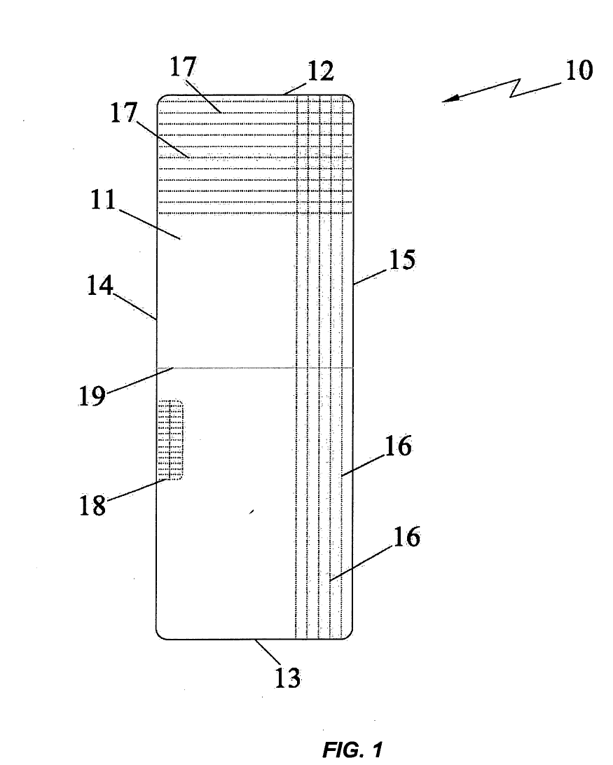

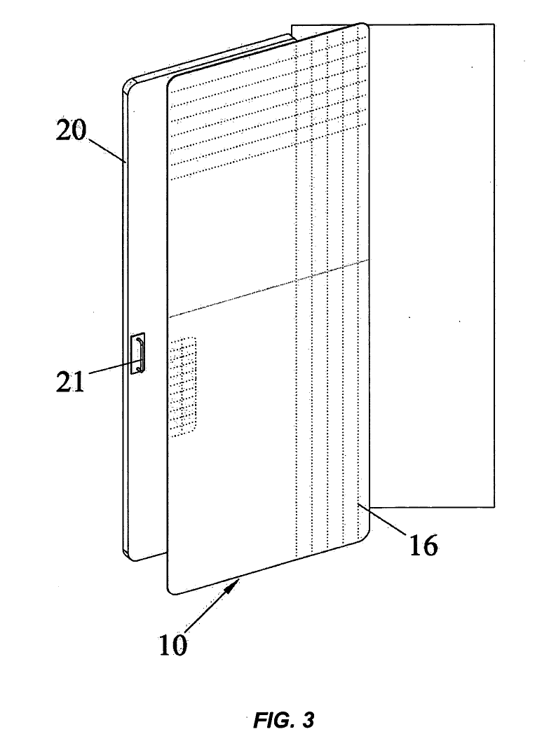

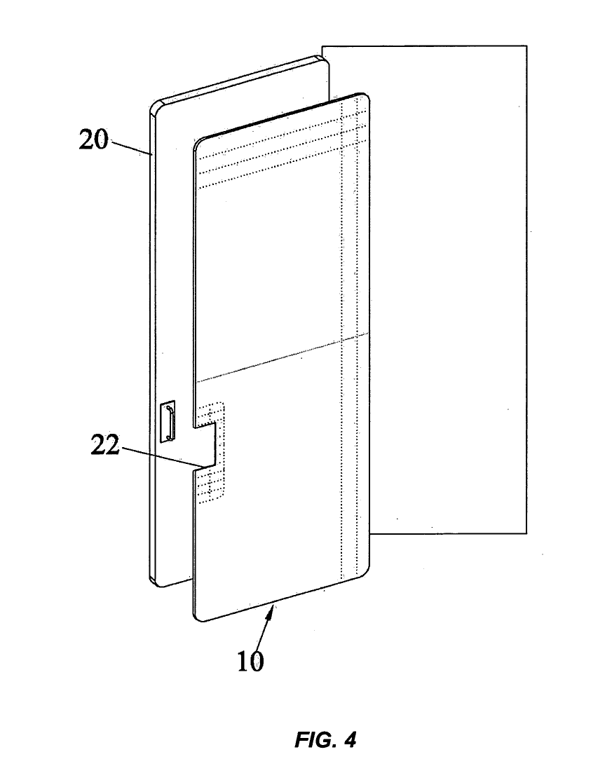

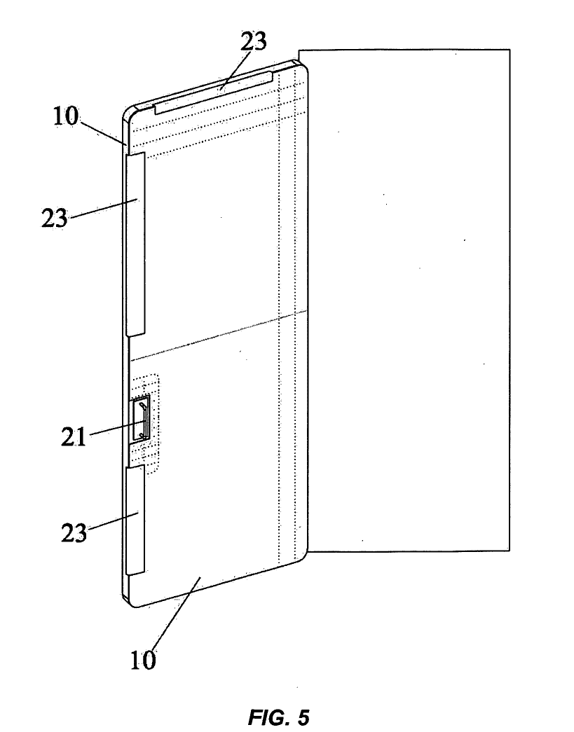

Referring to the drawings, a preferred embodiment of a door shield of the present invention is illustrated and generally indicated as 10 in FIGS. 1 through 5. The door shield 10 is adaptable to various door sizes.

Referring to FIG. 1, the door shield 10 comprises a rectangular panel 11 made of corrugated cardboard in a preferred embodiment. The panel has top 12, bottom 13, left 14 and right 15 edges. The panel includes perforations along a plurality of parallel and spaced apart vertical lines 16. The vertical lines 16 are at one side portion of the panel 11 and parallel to the right 15 and left 14 edges. The panel 11 also includes perforations along a plurality of parallel and spaced apart horizontal lines 17, parallel to the top 12 and bottom 13 edges. The perforations on the vertical lines 16 enable portions of the panel 11 to be removed along the vertical lines 16 to adjust to different widths of doors, whereas the perforations on the horizontal lines 17 enable portions of the panel to be removed along the horizontal lines 17 to adjust to different door lengths.

The panel further includes perforations along grid lines 18 opposite the vertical lines 16, in a preferred embodiment approximately midway between the bottom most horizontal line and the bottom edge 13, as seen in FIG. 1. Portions of the panel 11 may be removed along the perforations on the grid lines 18 to make a hole for accommodating door knobs or handles of various sizes and designs. The location and area covered by the handle grid 18 match typical locations for door handles, which are approximately in the middle of a door along the edge. The door shield can be folded in half along a fold line 19, to reduce its size prior to, and after use.

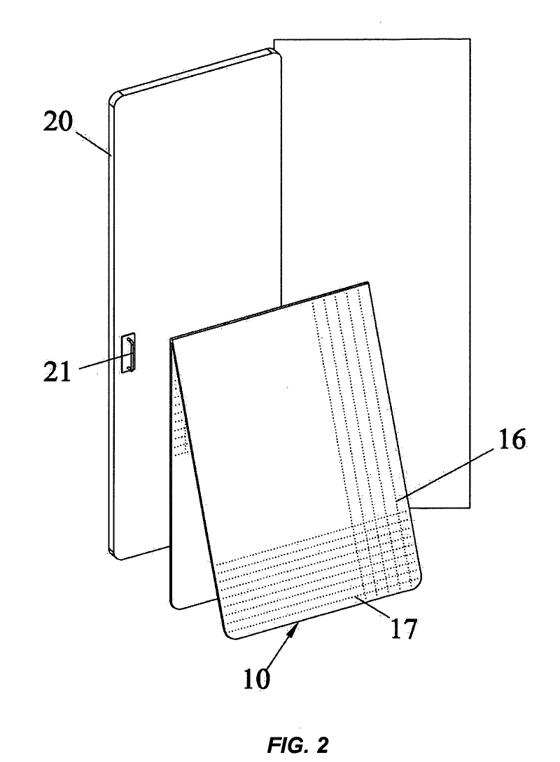

Referring to FIGS. 2 through 5, in order to use the door shield 10, it is unfolded to assume a flat configuration. The door shield 10 is then adjusted to the dimensions of the door 20 by removing portions of the panel 11 along the vertical and horizontal lines 16 and 17. Depending on the location and size of the door handle 21, appropriate portions of the area comprising the handle grid 18 are removed along the grid lines to form a hole 22. The adjusted door shield is then placed on the surface of the door 20 and the door handle 21 is received through the hole 22. The door shield 10 is then secured to the door using a securing means, including low tack adhesive tape 23, painters tape or other types of adhesive means that will not damage the door.

The dimensions of the door shield 10 and the distance between the consecutive vertical lines 16 and horizontal lines 17 make the door shield usable with doors of all sizes. In one preferred embodiment, the length of the door shield is 99 inches, the width is 35 inches, and the distance between the consecutive vertical lines 16 and horizontal lines 17 is two inches; the rightmost vertical line is at a distance of two inches from the left edge and a topmost horizontal line is at a distance of two inches from the top edge. However, other embodiments are contemplated, with difference dimensions for the door shield 10, vertical 16 and horizontal 17 lines, and handle grid 18.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A protective door shield comprising:
a) a panel having vertical and horizontal edges; and
b) a means of removing portions of the panel along the edges to change the size of the panel.

2. The protective door shield of claim 1, wherein the panel is a quadrilateral shape, including a rectangle.

3. The protective door shield of claim 1, wherein the panel is the size of a door or doorway.

4. The protective door shield of claim 1, wherein the door shield may be folded along one or more axes.

5. The protective door shield of claim 4, wherein the door shield may be folded in half along its vertical mid-section.

6. The protective door shield of claim 1, comprising a means to remove a portion of the shield near a door handle, allowing the door handle to cross through the plane of the shield.

7. The protective door shield of claim 6, wherein the means to remove a portion of
the shield near a door handle comprises perforated indicator lines.

8. The protective door shield of claim 1, wherein the means of removing portions of the panel comprises perforated indicator lines running the length of one or more edges of the panel.

9. The protective door shield of claim 8, wherein the indicator lines run along horizontal and vertical axes.

10. The protective door shield of claim 9, wherein the perforated indicator lines are spaced apart, run parallel with the edges of the panel, and extend inward from the edges of the panel.

11. The protective door shield of claim 10, wherein the perforated indicator lines are spaced between 0.5 and five inches apart.

12. The protective door shield of claim 11, wherein the perforated indicator lines are spaced evenly apart.

13. The protective door shield of claim 11, wherein the perforated indicator lines are spaced apart with increasing or decreasing distance between them.

14. The protective door shield of claim 1, wherein the panel is comprised of cardboard, corrugated cardboard, plastic, or a combination of materials.

15. The protective door shield of claim 1, wherein the panel further comprises measurement data and other grid lines to indicate the size and position of the panel relative to a door, doorway, another object or space.

16. A protective door shield comprising:
a) a rectangular cardboard panel which folds along its horizontal axis at its vertical midpoint;
b) a series of horizontal and vertical perforations along horizontal and vertical indicator lines, forming a grid on the left edge of the panel, so that the grid corresponds with the position of a door handle, so that one, all, or a combination of portions of the grid may be removed to accommodate a door handle, allowing it to pass through the panel;
c) a series of horizontal and vertical perforations along indicator lines running the length of the panel on its right edge and across the top of the panel parallel, so that one or more portions of the panel defined by the area between the indicator lines and the edge of the panel may be removed from the panel, to adjust the size of the panel.
